(19) United States
(12) Patent Application Publication
(10) Pub. No.: US 2002/0009561 A1
(43) Pub. Date: Jan. 24, 2002

(54) LUBRICATED ELASTOMERIC ARTICLE

(76) Inventors: WILLIAM JOSEPH WEIKEL, ESCONDIDO, CA (US); DAVID W. JOHNSON, ESCONDIDO, CA (US)

Correspondence Address: DORITY & MANNING, P.A., POST OFFICE BOX 1449, GREENVILLE, SC, 29602-1449, US

(21) Appl. No.: 09/134,725

(22) Filed: Aug. 15, 1998

(51) Int. Cl. B32B 1/02

(52) U.S. Cl. 428/35.7

(57) ABSTRACT

Disclosed is an elastomeric article, such as a glove, that includes a lubricant composition provided on an interior, wearer-contacting surface of the article, where the lubricant composition includes a wettable additive, such as a quaternary ammonium compound that includes an alkyl chain of at least 20 carbon atoms, and a silicone.

### BACKGROUND OF THE INVENTION

The invention relates to lubricating elastomeric articles.

Elastomeric gloves, such as medical gloves used by health professionals, have poor lubricity (also referred to as “slip”) and thus are difficult to don over dry and wet hands. In the past, elastomeric gloves have been coated with powdery substances to increase their lubricity, causing a corresponding improved ease of donning over dry skin. The powder, however, frequently remains on the hand after the glove is removed. The powdery residue can be irritating and tends to dry the skin.

Other methods designed to improve the donning characteristics of elastomeric gloves include, e.g., halogenating (e.g., chlorinating) the interior or wearer-contacting surface of a glove, and applying compositions that include surfactant and silicone to the interior surface of a glove.

### SUMMARY OF THE INVENTION

In one aspect, the invention features an elastomeric article (e.g., a glove) that includes a lubricant composition provided on an interior, wearer-contacting surface of the article. The lubricant composition includes a wettable additive, such as a quaternary ammonium compound that includes an alkyl chain of at least 20 carbon atoms, and a silicone.

In one embodiment, the quaternary ammonium compound includes a behentrimonium salt (e.g., behentrimonium methosulfate). In another embodiment, the silicone includes hydroxy terminal groups. In some embodiments, the silicone includes amodimethicone. In one preferred embodiment, the lubricant composition includes behentrimonium methosulfate and amodimethicone.

In another preferred embodiment, the amount of the wettable additive is about 0.25 to about 2.5% by weight, and the amount of the silicone is about 0.25 to about 2.5% by weight.

In other embodiments, the lubricant composition further includes a fatty alcohol having an alkyl chain of at least 12 carbon atoms (e.g., cetearyl alcohol).

In another aspect, the invention features an elastomeric glove that includes a composition provided on the interior wearer-contacting surface of the glove, where the composition includes a silicone and a wettable additive selected from the group consisting of self emulsifying waxes, cationic polymers, and combinations thereof. In one embodiment, the wettable additive is a self emulsifying wax that includes a behentrimonium salt. In another embodiment, the self emulsifying wax includes a fatty alcohol having an alkyl chain of at least 12 carbon atoms.

In still another aspect, the invention features a method for making a lubricated glove that includes coating the above-described compositions onto an elastomeric glove.

In another aspect, the invention features the above-described lubricant composition.

The invention provides elastomeric articles, such as gloves, that are easily donnable over dry, damp, and wet hands. The lubricant composition provided on the elastomeric article is mild and causes low levels to no irritation to the skin (e.g., does not promote erythema, flaking, or roughness). In addition, the wettable additive exhibits a relatively low cytotoxicity, and, in certain embodiments, the lubricant composition as a whole exhibits a relatively low cytotoxicity.

The lubricant composition also effects a relatively low transepidermal water loss and can act to moisturize, soften and protect the skin of the wearer.

Other features and advantages of the invention will be apparent from the following description of the preferred embodiments thereof, and from the claims.

### DESCRIPTION OF THE PREFERRED EMBODIMENTS

The elastomeric article includes a lubricant composition that provides sufficient lubricity on the interior surface of the article to permit relatively easy donning of the article over dry, damp, and wet skin. The lubricant composition includes a wettable additive and a silicone.

The wettable additive is selected to exhibit relatively low levels of or no skin irritation. One indicator of skin irritation is cytotoxicity. The wettable additive may be selected such that it exhibits low levels of or no cytotoxicity. For example, a wettable additive that exhibits a reduction in cell viability of no more than 20% after 24 hours, as measured according to the Mat Tek Epiderm Skin Model assay, may be selected.

The wettable additive may be selected from the group consisting of self emulsifying waxes, cationic polymers, and combinations thereof.

Suitable self emulsifying waxes can be cationic, anionic, or nonionic. One preferred category of self emulsifying waxes includes cationic quaternary ammonium compounds having an alkyl chain of at least 20 carbon atoms. An example of a particularly preferred quaternary ammonium compound is behentrimonium methosulfate (which is commercially available as a mixture of behentrimonium methosulfate and cetearyl alcohol, e.g., under the trade designation Incroquat Behenyl TMS, from Croda, Inc.).

Examples of other useful self emulsifying waxes include emulsifying wax NF (commercially available under the product designation Polawax, from Croda, Inc.), mixtures of cetearyl alcohol and cetearyth-20 (commercially available, e.g., under the trade designation Cosmowax, from Croda, Inc.), glyceryl stearate SE (commercially available, e.g., under the trade designation Lexemul 530), and combinations thereof. Other useful self emulsifying waxes include, e.g., mixtures of stearyl alcohol and ceteareth 20 (Croda Cosmo wax K), mixtures of cetearyl alcohol and PEG-40 castor oil and stearalkonium chloride (Croda Incroquat CR Concentrate), mixtures of behenamidopropyl ethyldimonium ethosulfate and stearyl alcohol (Croda Incroquat BES-35S), glyceryl laurate SE, glyceryl oleate SE, PEG-2 stearate, PEG-2 oleate, PEG-2 laurate, and combinations thereof.

Other compositions that exhibit self emulsifying wax-like properties include mixtures of fatty alcohols or fatty esters, and nonionic surfactants, anionic surfactants, and cationic surfactants having at least 20 carbon atoms, and combinations thereof. Suitable fatty alcohols include straight and branched chain, saturated and unsaturated alcohols of at least 12 carbon atoms. Examples of useful fatty alcohols include lauryl alcohol, myristal alcohol, cetyl alcohol, stearyl alcohol, cetearyl alcohol, and combinations thereof. An example of a useful anionic surfactant is sodium cocoyl isethionate (commercially available under the trade designation Geropon AS-200, from Rhone-Poulenc).

Suitable cationic polymers include cellulose, collagen, and vinylpyrolidone derived cationic polymers, and combinations thereof. Examples of useful cellulose derived polymers include: the reaction product of hydroxyethyl cellulose and trimethyl ammonium substituted epoxide, e.g., Ucare Polymer JR 400 (commercially available from Amerchol) and Celquat SC 240 (commercially available from National Starch); and the reaction product of polymeric quaternary ammonium salts of hydroxy ethylcellulose and lauryl dimethyl ammonium substituted epoxide (commercially available, e.g., under the trade designation Quatrisoft Polymer LM-200 from Amerchol). Examples of other useful cationic polymers include polyquaternium proteins such as e.g., Quat-Coll IP-10 (commercially available from Brooks Industries), polyquaternium-11 and polyquaternium-28 (both of which are commercially available, e.g., under the trade designation Gafquat from ISP), and combinations thereof.

The silicone can be a reactive silicone, a non-reactive silicone, or a mixture of reactive and non-reactive silicones. Suitable silicones include, e.g., aminosilicones (e.g., amodimethicone), polyether-modified amino silicones, epoxy silicones, quaternary silicones, dimethicone, silicone polyethers, polyether epoxy silicones, silanol fluids, polysiloxy linoleyl pyrrolidone phospholipid, and combinations thereof. Preferred silicones include amino-substituted siloxanes having hydroxy terminal groups.

The lubricant composition can also include other components such as, e.g., glucose derived polymers, or mixtures containing glucose derived polymers (e.g., lauryl glucoside (commercially available, e.g., under the trade designation Planteran PS 400, from Cospha (Henkel)), silicas, silica dispersions, additional wetting agents, preservatives, and combinations thereof.

The lubricant composition preferably includes about 0.1% to about 4% (more preferably about 0.25% to about 2.5%) by weight wettable additive, and about 0.1% to about 4% (more preferably about 0.25% to about 2.5%) by weight silicone. The lubricant composition is provided on the interior surface of the article in an amount sufficient to provide a article that is easily donnable over dry, damp and wet skin. Preferably the composition is provided at a coating weight of about 0.01 to about 0.2 g/glove Examples of suitable elastomeric compounds include natural rubber latex, nitrile rubber, neoprene, polyurethane, polyurethane coated nitrile, styrene-butadiene-styrene (SBS) copolymer, styrene-isoprene-styrene (SIS) copolymer, styrene-ethylene-butylene-styrene (SEBS) copolymer, vinyl, urethane, and silicone.

The elastomeric article is preferably a medical glove, e.g., a surgeon's glove.

The lubricant composition can be provided on the elastomeric articles according to a number of methods including, e.g., immersing the article in the lubricant composition for a period sufficient to coat the interior surface of the article. The articles can be treated, e.g., halogenated, prior to treatment with the lubricant composition. Useful methods for halogenating elastomeric gloves are described in, e.g., U.S. Pat. No. 3,411,982 (Kavalir), U.S. Pat. No. 3,740,262 (Agostinelli), U.S. Pat.No. 3,992,221 (Hornsy et al.), U.S. Pat. No. 4,597,108 (Momose), and U.S. Pat. No. 4,851,266 (Momose), the disclosures of which are incorporated in their entirety by reference.

The invention will now be described further by way of the following examples.

### EXAMPLES

### Lubricant Composition Preparation

A composition of 0.75% by weight GE Silicone SM2059 and 1.0% by weight Incroquat Behenyl TMS (Croda, Inc.) was prepared as follows. 10 g of Incroquat Behenyl TMS (which includes 20-30% by weight C₁₈₋₂₂ trimethyl ammonium methosulfate, 45-55% by weight hexadecanol, and 20-30% by weight octadecanol) was rapidly stirred into 982.5 g of water that had been heated to a temperature of about 55° C. to 75° C. The composition was stirred until all solids were dissolved. The stir rate was then reduced and the composition was allowed to cool to less than 50° C. 7.5 g of GE Silicone SM2059 (which includes 1-5% by weight coco alkyl bis(2-hydroxyethyl)-chlorides ethoxylated methyl quaternary ammonium, 1-5% by weight octylphenoxypolyethoxyethanol, 30-60% by weight aminoethylaminopropylpolysiloxane-hydroxy stopped, and 30-60% by weight water) was stirred into the cooled composition. Stirring continued for about 10 more minutes.

### Example 1

Chlorinated elastomeric surgeon's gloves were tumbled in the above-described lubricant composition for at least 5 minutes at approximately 20-30 rotations per minute. The lubricant composition was then drained from the tank and excess wettable additive was removed from the gloves via a high speed spin down.

Other embodiments are within the claims. For example, other lubricant compositions could include: 0.50% Quatrisoft Polymer LM200, 0.25% SM 2059 silicone, and 99.25% water; 1.00% Polawax emulsifying wax NF, 1.00% SM 2059 silicone, and 98.00% water; and 0.25% Polawax emulsifying wax NF, 0.50% Varisoft behentrimonium methosulfate (Witco), 0.50% SM 2059 and 98.75% water.

The lubricant composition can also be prepared by adding the wettable additive to a portion of the water and adding the balance of the water following the final cool down of the composition.

What is claimed is:

1. An elastomeric article comprising:
a lubricant composition provided on an interior, wearer-contacting surface of said article, said lubricant composition comprising
(i) a quaternary ammonium compound comprising an alkyl chain of at least 20 carbon atoms, and
(ii) a silicone.

2. The article of claim 1, wherein said quaternary ammonium compound comprises a behentrimonium salt.

3. The article of claim 1, wherein said quaternary ammonium compound comprises behentrimonium methosulfate.

4. The article of claim 1, wherein said silicone comprises hydroxy terminal groups.

5. The article of claim 1, wherein said silicone comprises amodimethicone.

6. The article of claim 1, wherein the amount of said wettable additive is about 0.25 to about 2.5% by weight, and the amount of said silicone is about 0.25 to about 2.5% by weight.

7. The article of claim 1, wherein said lubricant composition comprises behentrimonium methosulfate, and amodimethicone.

8. The article of claim 1, wherein said lubricant composition further comprises a fatty alcohol having an alkyl chain of at least 12 carbon atoms.

9. The article of claim 8, wherein said fatty alcohol comprises cetearyl alcohol.

10. The article of claim 1, wherein said article comprises an elastomeric glove.

11. An elastomeric glove comprising:
a lubricant composition provided on the interior wearer-contacting surface of said glove, said composition comprising
a silicone, and
a wettable additive selected from the group consisting of self emulsifying waxes, cationic polymers, or a combination thereof.

12. The glove of claim 11, wherein said wettable additive is a self emulsifying wax.

13. The glove of claim 12, wherein said self emulsifying wax comprises a behentrimonium salt.

14. The glove of claim 12, wherein said self emulsifying wax comprises behentrimonium methosulfate.

15. The glove of claim 11, wherein said silicone comprises hydroxy terminal groups.

16. The glove of claim 11, wherein said silicone comprises amodimethicone.

17. The glove of claim 12, wherein said self emulsifying wax comprises a fatty alcohol having an alkyl chain of at least 12 carbon atoms.

18. The glove of claim 17, wherein said fatty alcohol comprises cetearyl alcohol.

19. The glove of claim 11, wherein the amount of said wettable additive is about 0.25 to about 2.5% by weight, and the amount of said silicone is about 0.25 to about 2.5% by weight.

20. A method for making a lubricated glove comprising coating a composition onto an elastomeric glove, said composition comprising
a silicone, and
a wettable additive selected from the group consisting of self emulsifying waxes, cationic polymers, or a combination thereof.

21. The method of claim 20, wherein said wettable additive is a self emulsifying wax comprising a quaternary ammonium compound that comprises an alkyl chain of at least 20 carbon atoms.

22. A lubricant composition comprising:
a silicone, and
a wettable additive selected from the group consisting of self emulsifying waxes, cationic polymers, or a combination thereof.

23. The lubricant composition of claim 22, wherein said wettable additive is a self emulsifying wax that comprises behentrimonium methosulfate, and said silicone comprises amodimethicone.

24. The lubricant composition of claim 23, wherein the amount of said behentrimonium methosulfate is about 0.25 to about 2.5% by weight, and the amount of said amodimethicone is about 0.25 to about 2.5% by weight.
